(19) United States
(12) Patent Application Publication
(10) Pub. No.: US 2007/0010385 A1
(43) Pub. Date: Jan. 11, 2007

(54) Exchange system of rotary worktables

(75) Inventor: Sheng-Tun Wu, Taichung (TW)

Correspondence Address: BRUCE H. TROXELL, SUITE 1404, 5205 LEESBURG PIKE, FALLS CHURCH, VA, 22041, US

(73) Assignee: Kao Fong Machinery Co., Ltd.

(21) Appl. No.: 11/172,829

(22) Filed: Jul. 5, 2005

(51) Int. Cl. B23Q 3/155

(52) U.S. Cl. 483/14

(57) ABSTRACT

An exchange system includes a rotating mechanism and a table base connected to the rotating mechanism to exchange two worktables of a machine tool and a positioning device. The positioning device has a first positioning member, which is a pin on a top of a machine table of the machine tool and two second positioning members, which are holes on the table base. The first positioning member is detachably connected to the second positioning member to precisely position the table base on the machine table.

### BACKGROUND OF THE INVENTION

1. Field of the Invention

The present invention relates generally to a machine tool, and more particularly to an exchange system of rotary worktables.

2. Description of the Related Art

Conventional machine tools, such as horizontal multi-function machine tool, have an exchange system, which switches the main and second worktables to increase the efficiency and reduce the inconvenience of operation. The way of exchange of the worktables is that a rotating mechanism, which is controlled by a controller, moves a table base that connects the worktables for rotation and reciprocation along a predetermined path. Therefore, how to move the worktables to precise positions is the key issue for the exchange system.

The conventional exchange system, especially the rotating mechanism, is very expensive because the rotating mechanism has to move the worktables to precise positions. As long as the machine tool running for a period, the wear is occurred in the rotating mechanism that reduce the precision thereof. As a result, the exchange system works not so well after a time of use that reduces the efficiency of the machine tool.

### SUMMARY OF THE INVENTION

The primary objective of the present invention is to provide an exchange system of worktables, which moves the worktables to the precise positions and has lower requirements for the precision of the elements in size and rotating angle to reduce the cost of manufacture.

According to the objective of the present invention, an exchange system has a rotating mechanism and a table base connected to the rotating mechanism to exchange two worktables of a machine tool and a positioning device. The positioning device has a first positioning member provided on a top of a machine table of the machine tool and a second positioning member provided at a bottom of the table base. The first positioning member is detachably connected to the second positioning member to precisely position the table base on the machine table.

### BRIEF DESCRIPTION OF THE DRAWINGS

FIG. 1 is a perspective view of a preferred embodiment of the present invention;

FIG. 2 is an exploded view of the preferred embodiment of the present invention;

FIG. 2A is an exploded view of the positioning device of the preferred embodiment of the present invention;

FIG. 3 is a sectional view in parts of the preferred embodiment of the present invention, showing the disengagement of the positioning devices and the worktable, and

FIG. 4 is a sectional view in parts of the preferred embodiment of the present invention, showing the engagement of the positioning devices and the worktable.

### DETAILED DESCRIPTION OF THE INVENTION

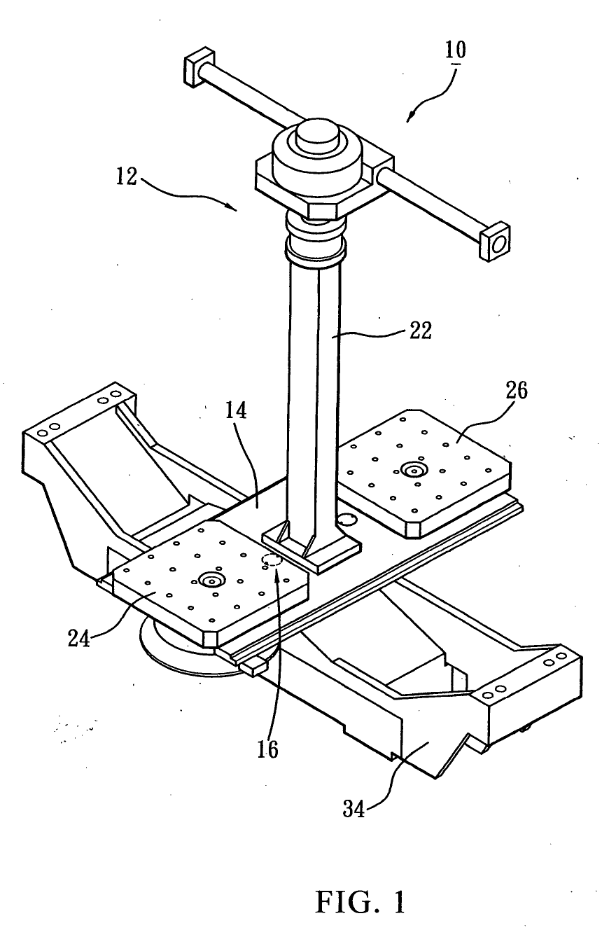

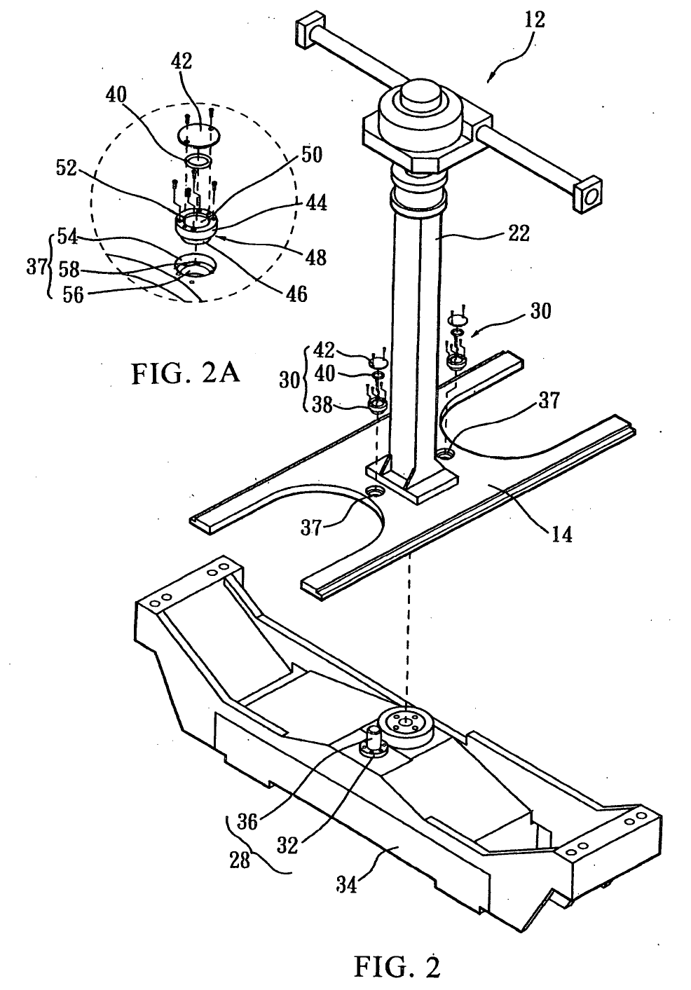

As shown in FIGS. 1 to 3, an exchange system 10 of the preferred embodiment of the present invention is installed on a horizontal multi-function machine tool (not shown), has a rotating mechanism 12 and a table base 14 mounted on a bottom end of a spindle 22 of the rotating mechanism 12 to switch worktables 24 and 26. The rotating mechanism 12 and the table base 14 are conventional devices that I won't describe the detail here. The exchange system 10 of the present invention further comprises:

A positioning device 16 includes a first positioning member 28 and two second positioning members 30.

The first positioning member 28 has a base 32 fixed on a table 34 of the machine tool and a first connecting portion 36, which is a pin, on a top of the base 32.

The second positioning members 30 are fixed in chambers 37 in the table base 14 at opposite sides of the spindle 22 respectively, each of which has a base member 38, an O ring 40 and a lid 42. The base member 38 has an upper ring member 44 and a lower ring member 46 on a bottom of the upper ring member 44. An outer diameter of the upper ring member 44 is greater than that of the lower ring member 46, such that the upper and lower ring members 44 and 46 form a downward resting portion at circumferences thereof and a second connecting portion 50, which is a hole, to be fitted to the first connecting portion 36 of the first positioning member 28. The upper ring member 44 has a recess 52 beside the second connecting portion 50 to receive the O ring 40. The lower ring member 46 has a guiding portion 53, which is a tilted face, at an edge of the second connecting portion 50. The lid 42 is secured on a top of the base member 38. Each of the chambers 37 has a first bore 54 and a second bore 56. The first bore 54 is greater than the second bore 56 and is communicated with the second bore 56, and a shoulder portion 58 is formed at a bottom of the first bore 54. A diameter of the first bore 54 is identical to that of the upper ring member 44, and a diameter of the second bore 56 identical to that of the lower ring member 46, such that the base members 38 are received in the chambers 37 respectively.

The exchange system 10 of the present invention has the positioning device 16 to position the table base 14 on a precise position of the machine table 34 for exchange of the worktables 24, 26.

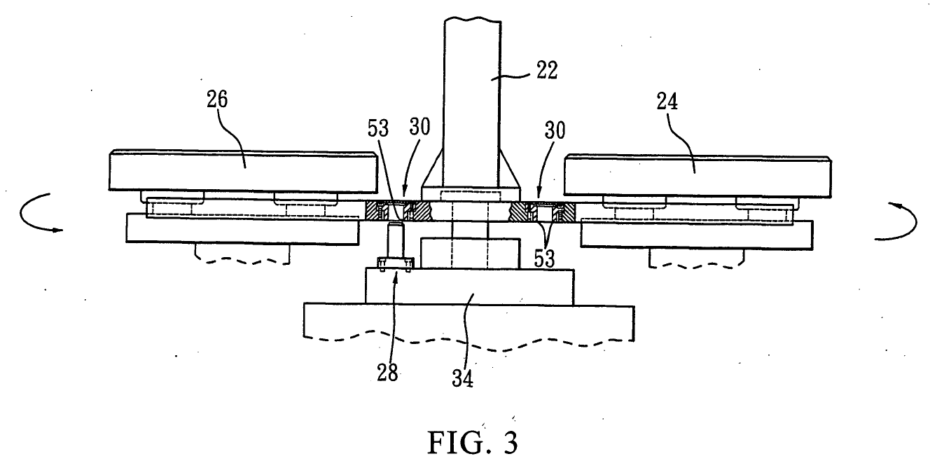

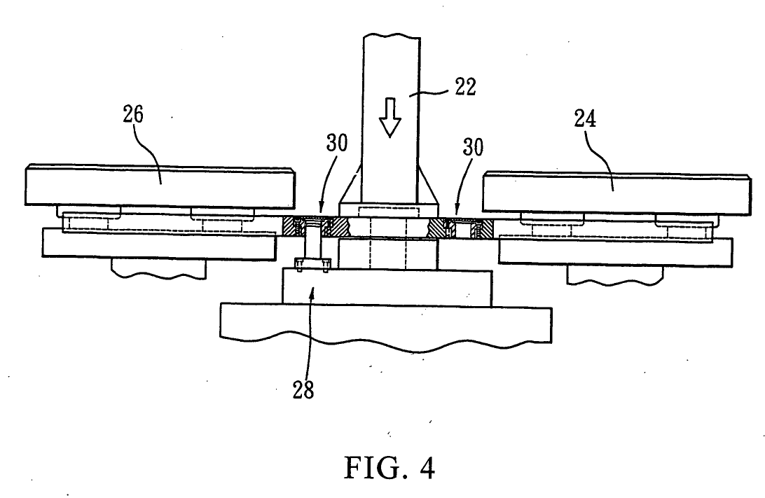

As shown in FIG. 3 and FIG. 4, when the worktables 24, 26 had been rotated for exchange, the second connecting portion 50 of the second positioning member 30 is located above the first connecting portion 36 of the first positioning member 28, and then the worktables 24, 26 are moved downwards to fit the second connecting portion 50 of the second positioning member 30 to the first connecting portion 36 of the first positioning member 28, such that the table base 14 are precisely fixed on the machine table 34 at a predetermined position for the next step of exchange.

The exchange system 10 of the present invention provides the positioning device 16 to precisely locate the table base 14 on the machine table 34, such that the precision requirement of the rotating mechanism 12 in size and in rotating angle is decreased and the cost of rotating mechanism 12 is lowered as well. After a time of operation of the exchange system 10 of the present invention, the elements of the rotating mechanism 12 are worn. The positioning device 16 of the present invention still precisely positions the table base 14 on the machine table 34.

It has to be mentioned that the first and second positioning members may be a pair of complementary elements for detachable connection. Any element like that shall be in the scope of the present invention.

In conclusion, the exchange system of the present invention provides the positioning device to precisely locate the table base on the machine table, such that the precision requirement of the rotating mechanism in size and in rotating angle is decreased and also the cost of rotating mechanism is lowered.

What is claimed is:

1. An exchange system, comprising a rotating mechanism, a table base connected to the rotating mechanism to exchange two worktables of a machine tool and a positioning device having a first positioning member provided on a top of a machine table of the machine tool and a second positioning member provided at a bottom of the table base; wherein the first positioning member is detachably connected to the second positioning member to precisely position the table base on the machine table.

2. The exchange system as defined in claim 1, wherein the first positioning member has a first connecting portion, and the second positioning member has a second connecting portion, which is complementary to the first connecting portion.

3. The exchange system as defined in claim 2, wherein the first positioning member has a base fixed on the top of the machine table, and the first connecting portion is provided on the base associated with the worktable, and the second positioning member has a base fixed on the table base, and the second connecting portion is provided on the base associated with the machine table.

4. The exchange system as defined in claim 3, wherein the first connecting portion is a pin, and the second connecting portion is a hole to be fitted to the pin.

5. The exchange system as defined in claim 4, wherein the base of the second positioning member has a guiding portion beside the second connecting portion associated with the first connecting portion.

6. The exchange system as defined in claim 5, wherein the guiding portion is a tilted face.

7. The exchange system as defined in claim 3, wherein the table base has a chamber, in which the second positioning member is received.

8. The exchange system as defined in claim 7, wherein the chamber has a first bore and a second bore, which the first bore has a diameter greater than that of the second bore to form a shoulder portion at a bottom of the first bore, and the base has an upper ring member and a lower ring member, which the upper ring member has a diameter greater than that of the lower ring member to form a resting portion at a bottom of the upper ring member, and the upper ring member is received in the first bore, and the lower ring member is received in the second bore, and the resting portion is rested on the shoulder portion.

9. The exchange system as defined in claim 4, wherein the second positioning member further has a lid provided on the base.

10. The exchange system as defined in claim 1, wherein the exchange system has two of the second positioning members to be connected to the first positioning member respectively when the table base is rotated.
